(19) United States
(12) Patent Application Publication
(10) Pub. No.: US 2002/0104208 A1
(43) Pub. Date: Aug. 8, 2002

(54) Installation mechanism for expandable locking sleeve

(76) Inventors: John M. Kurdziel, Fort Wayne, IN (US); Ronald W. Neuhaus, Fort Wayne, IN (US)

Correspondence Address: BAKER & DANIELS, 111 E. WAYNE STREET, SUITE 800, FORT WAYNE, IN, 46802

(21) Appl. No.: 09/896,545

(22) Filed: Jun. 29, 2001

Related U.S. Application Data
(60) Provisional application No. 60/267,751, filed on Feb. 8, 2001.

(51) Int. Cl. B23P 19/02

(52) U.S. Cl. 29/235

(57) ABSTRACT

An installation tool for expanding a locking sleeve for interlocking ends of the sleeve, the tool including a hydraulic cylinder driving a clamp or push block having at least one engagement surface parallel to an edge surface of one of the interlocking ends of the sleeve. More specifically, the clamp or push block includes a pair of engagement members having at least one engagement surface parallel to the edge of one of the interlocking ends of the sleeve. During use, an anchor extending from the cylinder is inserted within an aperture adjacent one interlocking end of the sleeve, and the engagement surfaces are abutted against the other interlocking end of the sleeve. Thereafter, the clamp or push block is driven by the cylinder to bear against the edge of such interlocking end of the sleeve, thereby expanding the sleeve until the ends of the sleeve interlock to lock the sleeve in a radially expanded sealing condition.

### CROSS REFERENCE TO RELATED APPLICATIONS

This application is related to and claims the benefit under 35 U.S.C. § 119(e) of U.S. Provisional Application Serial No. 60/267,751, entitled INSTALLATION MECHANISM AND METHOD FOR EXPANDABLE LOCKING SLEEVE, filed on Feb. 8, 2001.

### BACKGROUND OF THE INVENTION

1. Field of the Invention.

The present invention relates to installing radially expandable locking sleeves having interlocking end portions to hold the circumferential shape of the sleeve and to effect a seal between a porthole in a manhole riser or other concrete structure and a gasket which surrounds a pipe fitted into the porthole. More particularly, the present invention relates to an installation tool for expanding the sleeve and interlocking the sleeve end portions.

2. Description of the Related Art.

U.S. Pat. No. 4,478,437 discloses a radially expandable locking sleeve, having interlocking end portions, for providing a fluid tight seal between a gasket which surrounds a pipe and a porthole in the wall of a manhole base section. The aforementioned '437 patent is assigned to the assignee of the present application, and is expressly incorporated herein by reference. One of the interlocking ends of the sleeve includes a recess portion having a pair of ledge portions on the opposite sides thereof, and the other interlocking end of the sleeve includes a tab having a pair of fingers on the opposite sides thereof. In a pre-installation position, the interlocking end portions of the sleeve are overlapped such that the sleeve is in a collapsed condition having a decreased diameter.

In order to expand the sleeve to effect the seal, the collapsed sleeve is placed within the gasket, and a scissor-type installation tool is used to expand the sleeve. The scissor-type installation tool includes a pair of scissor arms having spreader pins on the distal ends thereof which fit within apertures in the sleeve located adjacent each interlocking end portion. A hydraulic cylinder is operatively connected between the scissor arms which, when actuated, spreads the scissor arms which in turn spread the interlocking end portions of the sleeve. When the tab of one of the interlocking end portions clears the end edge of the other interlocking end portion, the tab engages within the recess in the other interlocking end portion to lock the sleeve in an expanded condition to effect a fluid tight seal between the gasket and the porthole of the manhole base section.

A problem with the foregoing arrangement is that during installation of the sleeve, there is the possibility for lateral movement of the interlocking end portions of the sleeve relative to one another before the interlocking end portions become interlocked. Specifically, the engagement between the spreader pins of the scissor arms of the installation tool with the apertures in the interlocking end portions of the sleeve facilitates the radial expansion of the interlocking end portions, but may not prevent lateral movement of the interlocking end portions with respect to one another during such radial expansion. Problematically, any such relative lateral movement between the interlocking end portions of the sleeve misaligns the interlocking end portions, and thereby increases the difficulty of installing the sleeve within the gasket.

Another known installation tool, disclosed in U.S. Pat. No. 4,711,455, includes a piston and cylinder combination in which a piston is extended outwardly from the cylinder to spread apart and engage ends of an expandable sleeve. For example, the piston may include a flat plate secured thereto externally of the cylinder, which plate abuts one of the ends of the sleeve such that when the piston is moved outwardly from the cylinder by a hydraulic mechanism, the sleeve ends are slowly spread apart until such ends engage one another.

A problem associated with the above arrangement is the bending of the extended piston. Specifically, as the piston extends outwardly of the cylinder to spread the ends of the sleeve apart, the piston experiences forces which oppose the piston's extension. When such forces act directly against the piston in a direction parallel to the direction of extension of the piston, the forces are not strong enough to overcome the hydraulic mechanism to cause retraction of the piston. However, such forces also act on the piston in a direction perpendicular to the direction of expansion of the piston, thereby causing the extended piston to bend. Problematically, bending of the piston makes the piston less effective in spreading the sleeve ends apart, and also causes the piston to wear against the cylinder bore, resulting in a shortened period of usage for both the piston and the cylinder. Furthermore, bending of the piston to a significant degree may cause the extended piston to disengage from the cylinder.

What is needed is an installation tool which obviates the foregoing problems, and facilitates the easier expansion of the interlocking end portions of the sleeve into interlocking engagement with one another to effect a fluid tight seal between a gasket and a porthole in the wall of a manhole base section or other concrete structure.

### SUMMARY OF THE INVENTION

The present invention provides an installation tool for expanding a locking sleeve for interlocking end portions of the sleeve, the tool including a hydraulic cylinder which drives a piston to which a clamp or push block is attached, the clamp or push block having at least one engagement surface which is parallel to a corresponding mating edge surface of one of the interlocking end portions of the sleeve.

More specifically, the clamp or push block includes a pair of engagement members, each having at least one engagement surface which is parallel to at least one mating edge surface of one of the interlocking ends of the sleeve. The push block may include a pair of such engagement surfaces, wherein each of which are disposed parallel with respective mating engagement surfaces on the end portion of the sleeve. During use of the installation tool, an anchor pin extending from the hydraulic cylinder is inserted within an aperture adjacent an interlocking end portion of the sleeve to anchor the installation tool, and the engagement surfaces of the engagement members of the clamp or push block are abutted against the other interlocking end portion of the sleeve. Thereafter, the clamp or push block is driven by the hydraulic cylinder to bear against the edge of such interlocking portion of the sleeve, thereby expanding the sleeve until the end portions of the sleeve interlock with one another to lock the sleeve in a radially expanded sealing condition.

The engagement between the engagement surfaces of the clamp or push block and the edge of one of the interlocking end portions of the sleeve prevents relative lateral movement between the first and second end portions of the sleeve, because the engagement surfaces of the teeth are parallel with corresponding mating edge surfaces of one of the end portions of the interlocking sleeve. Advantageously, because relative lateral movement between the interlocking end portions of the sleeve is thereby prevented, expansion of the sleeve to the locked sealing condition may be effected much more easily than with use of the prior scissor-type installation tool described above.

In one embodiment, a push block is attached to the piston and disposed externally of the cylinder. An annular locking member, threadedly secured within the cylinder bore after the piston is inserted therein, functions as a stop member to engage a protrusion on the piston when the piston is extended from the cylinder to prevent the piston from separating from the cylinder. The stop member and piston also include annular grooves therein in which annular seals are disposed to provide a double seal between the piston and the cylinder. Each of the foregoing features provides increased structural integrity to the installation tool.

Additionally, the push block includes a first portion attached to the end of the piston, and a second portion which extends along and slidingly abuts the underside of the cylinder in each of the retracted and extended positions of the piston. Advantageously, the abutting engagement between the cylinder and the second portion of the push block transfers the non-axial bending forces, which may act in a direction substantially perpendicular to the length of the piston, from the piston to the cylinder, thereby effectively spreading such forces over both the piston and the cylinder of the installation tool to prevent bending of the extended piston.

In one form thereof, the present invention provides a tool for radially expanding a circular sleeve against a gasket, the sleeve having interlocking end portions, at least one of the interlocking end portions having an edge surface, the tool including a cylinder having a bore therein, the bore defining an open end of the cylinder; a piston slidably disposed within the bore; a push block attached to the piston and disposed externally of the cylinder, the push block having at least one engagement member disposed parallel with the edge surface one of the interlocking end portions of the sleeve for engagement therewith, wherein the piston is movable within the cylinder between a first position in which the push block is located adjacent the cylinder to a second position wherein the push block is spaced away from the cylinder.

In another form thereof, the present invention provides a tool for radially expanding a circular sleeve against a gasket, the sleeve having interlocking end portions, at least one of the interlocking end portions having an edge surface, the tool including a cylinder having a bore therein, the bore defining an open end of the cylinder; a piston slidably disposed within the bore and moveable between a first position and a second position; a push block attached to the piston, the push block including a first portion disposed adjacent the open end of the cylinder when the piston is in the first position, the push block further including a second portion disposed beneath the cylinder and abutting the cylinder when the piston is in each of the first and second positions.

In a further form thereof, the present invention provides a tool for radially expanding a circular sleeve against a gasket, the sleeve having interlocking end portions, at least one of the interlocking end portions having an edge surface, the tool including a cylinder having a first bore therein defining an open first end of the cylinder, the cylinder further including a second end opposite the first end, the second end including a second bore therein; a piston slidably disposed within the first bore, the piston including a push block attached to an end thereof and disposed externally of the cylinder; and an anchor member removably disposed within the second bore, the anchor member having a portion extending externally of the cylinder.

In a still further form thereof, the present invention provides a tool for radially expanding a circular sleeve against a gasket, the sleeve having interlocking end portions, at least one of the interlocking end portions having an edge surface, the tool including a cylinder having a bore therein defining an open end of the cylinder, the cylinder further including an annular groove disposed around the bore; a piston slidably disposed in the bore; an annular stop member threadedly received in the open end of the cylinder, the stop member having an internal annular groove therein; at least two seals, one of the seals being located in each of the cylinder annular groove and the stop member annular groove, the seals each abutting the piston whereby a double seal is provided between the piston and the cylinder.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a perspective, partially cutaway and sectioned view of an exemplary seal installation, including a locking sleeve in an expanded and interlocked condition, effecting a fluid tight seal between a gasket and a porthole in the wall of a manhole riser;

FIG. 2 is a fragmentary perspective view of an interlocking end portion of the sleeve;

FIG. 3 is a fragmentary perspective view of another interlocking end portion of the sleeve;

FIG. 4 is a side view of the sleeve in a collapsed condition;

FIG. 5 is a side view of the sleeve of FIG. 3, the sleeve shown in an expanded condition with the interlocking end portions thereof interlocked;

FIG. 6 is an end view of a seal installation, showing the installation tool in accordance with the present invention operatively engaging the expandable locking sleeve;

FIG. 7 is a side view of the installation tool of FIG. 6;

FIG. 8 is a top view of the installation tool of FIG. 6;

FIG. 9 is an end view of the installation tool of FIG. 6;

FIG. 10 is a fragmentary view of a portion of FIG. 6, showing the engagement of the anchor post of the installation tool with an opening in an end portion of the sleeve;

FIG. 11A is a top view of a second embodiment of an installation tool assembly according to the present invention;

FIG. 11B is a side view of the installation tool assembly of FIG. 11A;

FIG. 11C is an end view of the installation tool assembly of FIG. 11A;

FIG. 12A is a side view of the cylinder of the installation tool of FIG. 11A;

FIG. 12B is a top view of the cylinder of FIG. 12A;

FIG. 12C is an end view of the cylinder of FIG. 12A;

FIG. 13A is an end view of a stop member for the installation tool of FIG. 11A;

FIG. 13B is a sectional view of the stop member of FIG. 13A, along line 13B-13B of FIG. 13A;

FIG. 14A is a side view of a piston of the installation tool of FIG. 11A;

FIG. 14B is an end view of the piston of FIG. 14A;

FIG. 15A is a side view of a push block of the installation tool of FIG. 11A;

FIG. 15B is an end view of the push block of FIG. 15A;

FIG. 15C is a bottom view of the push block of FIG. 15A;

FIG. 16A is a side view of a stud of the installation tool of FIG. 11A; and

FIG. 16B is an end view of the stud of FIG. 16A.

Corresponding reference characters indicate corresponding parts throughout the several views. The exemplifications set out herein illustrates preferred embodiments of the invention, and such exemplifications are not to be construed as limiting the scope of the invention in any manner.

### DETAILED DESCRIPTION

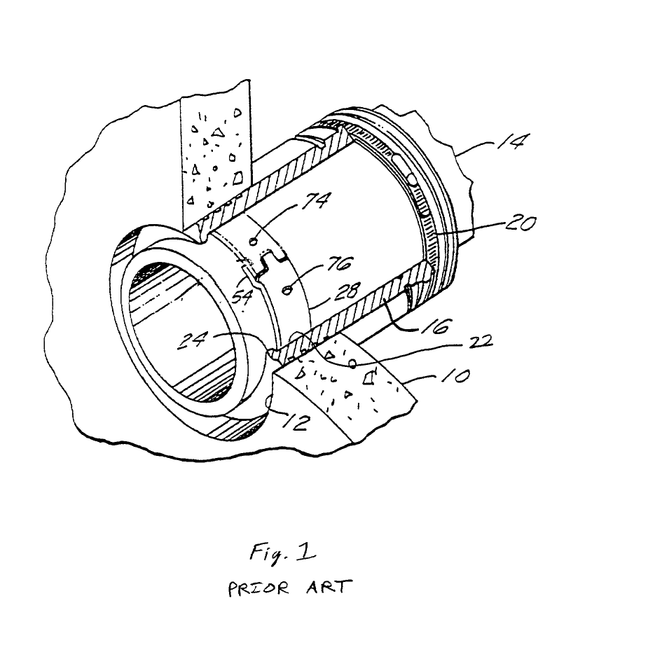

Referring to the drawings, and more particularly to FIG. 1, a reinforced concrete manhole base section or other concrete structure, generally indicated by the numeral 10, is provided with a conventional pipe-receiving opening 12 in the wall thereof. Pipe 14, formed of concrete, plastic or the like, is received within opening 12 and penetrates to a position beyond the wall of manhole base section 10.

To seal pipe 14 within opening 12, a gasket 16 is employed which includes an elongated sleeve of resilient, elastomeric material, such as rubber, neoprene or suitable plastic. Pipe 14 is received through gasket 16 and clamping band 20 is tightened to provide a seal between the inner surface of gasket 16 and the exterior of pipe 14. A radially expandable locking sleeve 28 is coaxially received within gasket 16 and more particularly within cylindrical seat 22 defined adjacent rib 24 of gasket 16. With sleeve 28 expanded radially to its maximum diameter, the portion of gasket 16 radially opposite sleeve 28 is sealingly compressed against the wall of opening 12 as shown to provide a fluid tight seal between gasket 16 and the wall of opening 12.

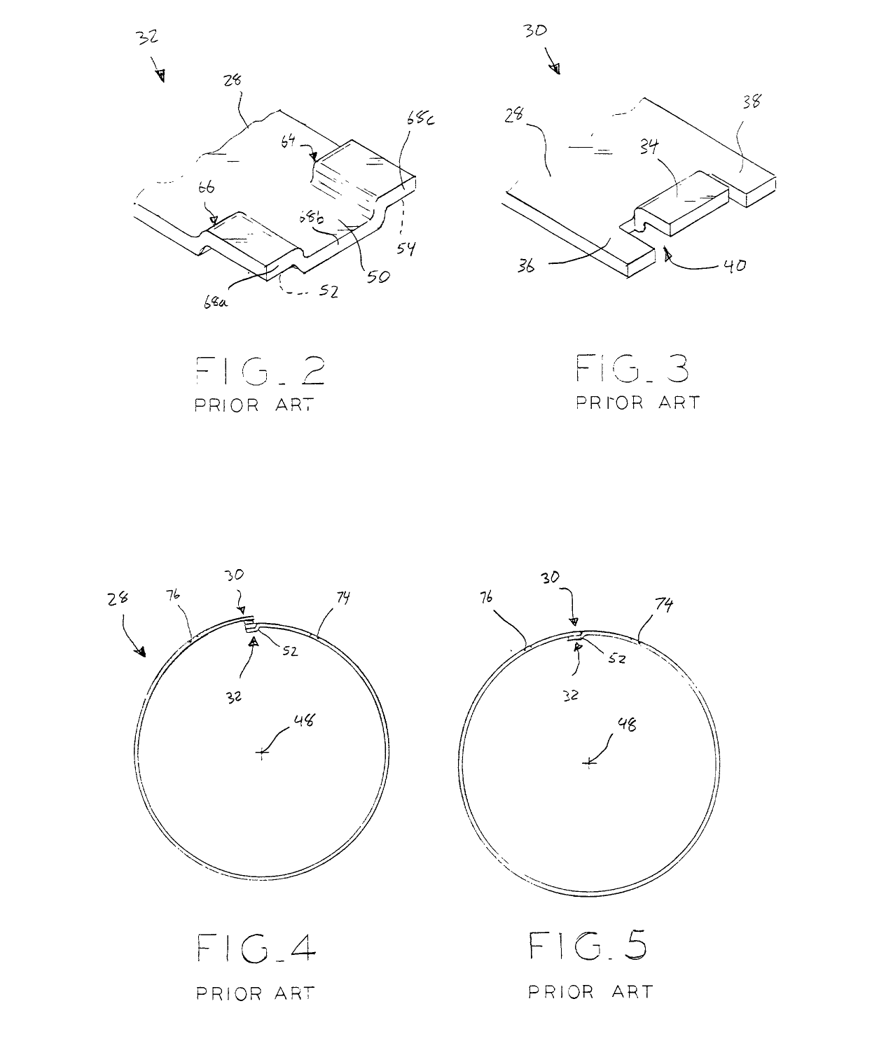

Sleeve 28 is more clearly shown in FIGS. 2-5, and is formed of a flat steel strip of substantially uniform thickness cut to length and formed to an annular shape with the outer surface being cylindrical. The sleeve is axially split to provide interlocking end portions 30, 32 which may be overlapped as shown in FIG. 4 to reduce the diameter of sleeve 28. End portion 30, shown in FIG. 3, is formed to provide a radially outset tab 34 which extends circumferentially from the body of sleeve 28 and includes two circumferential extensions or fingers 36, 38 on opposite sides thereof. Tab 34 is radially displaced outwardly from the adjacent portion of sleeve 28 to form a notch 40 in conjunction with fingers 36, 38 having a width substantially equal to the thickness of the strip of which sleeve 28 is formed. End portion 32, shown in FIG. 2, includes edges 68a-c, recess portion 50, and two laterally extending ledge portions 52 and 54 on opposite sides thereof having abutment steps 64, 66.

With sleeve 28 coiled to a smaller diameter as shown in FIG. 3 with the end portions 30, 32 overlapped, tab 34 engages the inner surface of recess portion 50. Upon radial expansion of sleeve 28, end portions 30, 32 spread apart until the distal end of tab 34 of end portion 30 just clears the end edge 68b of end portion 32, permitting fingers 36, 38 of end portion 30 to engage ledge portions 52, 54 of end portion 32. This brings the distal ends of fingers 36, 38 into abutting alignment with abutment steps 64 and 66 of end portion 32, respectively. The overlapping and interlocked portions of the sleeve ends are so proportioned and dimensioned that when interlocked, the circumferential surface of the sleeve continues substantially uninterruptedly across the formed joint, as may be seen in FIG. 1. Sleeve includes openings 76, 74 in end portions 30, 32, respectively, and axis 48, as shown in FIGS. 4-6. Further details regarding the interlocking of end portions 30, 32 of sleeve 28 are set forth in U.S. Pat. No. 4,478,437.

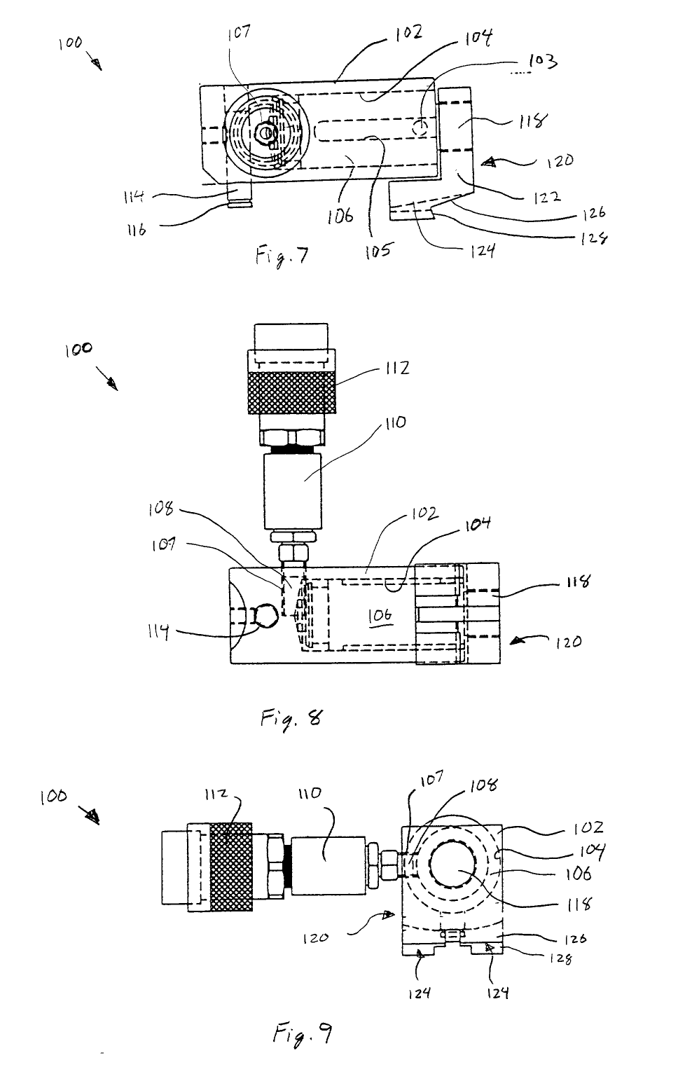

Referring to FIGS. 1, 6, and 10, and also to FIGS. 7-9 which show the installation tool in accordance with one embodiment of the present invention, the installation of gasket 16 within opening 12 using such installation tool will now be explained. Gasket 16 is first installed into opening 12 in coaxial alignment therewith. Gasket 16 is quite flexible and has merely loose engagement, if any, with the wall of opening 12. Next, sleeve 28, unlocked and overlapped as shown in FIG. 3, is inserted within gasket 16 and more particularly within seat 22 adjacent to rib 24.

Installation tool 100 is shown in FIGS. 7-9, and includes cylinder 102 having bore 104 therein in which piston 106 is slidably disposed. Cylinder 102 includes stop 103 which engages groove 105 in piston 106 to limit travel of piston 106 outward of cylinder 102. Cylinder 102 also includes threaded fitting 107 for receiving threaded end 108 end of hydraulic fitting 110. Hydraulic fitting 110 includes sleeve 112 for releasable connection to a hydraulic line to supply hydraulic fluid to cylinder 102. Cylinder 102 further includes anchor post 114 threaded thereinto, having groove 116 on an end thereof external of cylinder 102 for engagement within opening 76 of end portion 30, as described below.

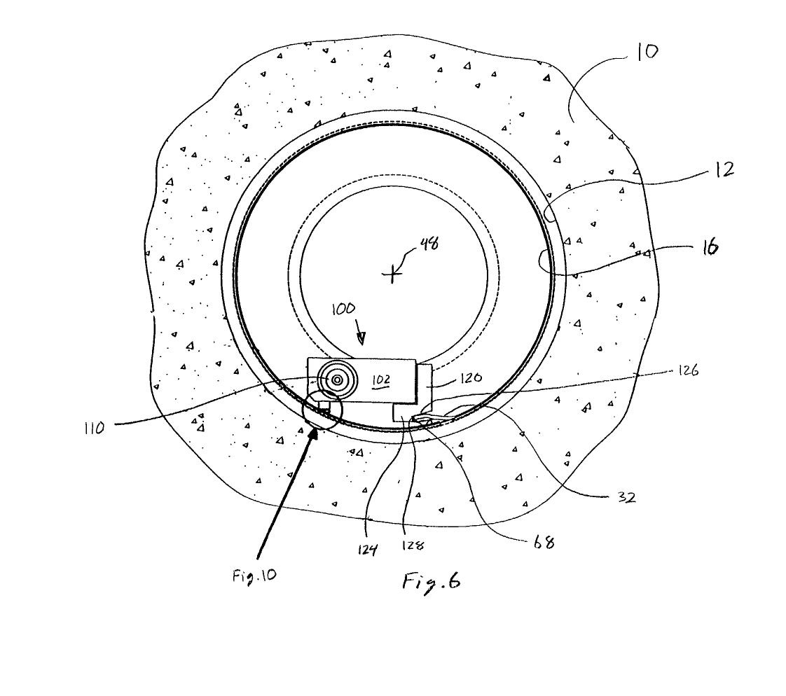

Piston 106 includes threaded end portion 118 having clamp 120 threaded thereon. Clamp 120 includes head 122 having a pair of engagement teeth 124 extending therefrom. Engagement teeth 124 have a pair of engagement surfaces, including inwardly directed ramp surface 126 and outwardly directed ramp surface 128, each of which is parallel to axis 48 of sleeve 28 and to end edge 68 of end portion 32 of sleeve 28 when installation tool 100 is operatively attached to sleeve 28, as shown in FIG. 6.

Referring to FIG. 6, the locking of sleeve 28 within gasket 16 is shown. Installation tool 100 is operatively attached to gasket 16 by first inserting anchor post 114 within opening 76 of end portion 30 of sleeve 28 such that the wall of opening 76 engages within groove 116 of anchor post 114. Clamp 120 is then aligned with end portion 32 such that engagement surfaces 126, 128 of engagement teeth 124 are aligned with end edges 68a and 68c of end portion 32. Thereafter, pressurized hydraulic fluid is introduced through hydraulic fitting 110 into cylinder 102 through any suitable means, such as a hydraulic foot pump (not shown), and piston 106 and clamp 120 are driven outwardly, and generally away from anchor post 114, to engage engagement surfaces 126, 128 of engagement teeth 124 with end edges 68a and 68c of end portion 32 of sleeve 28. Further driving of piston 106 and clamp 120 expands sleeve 28 until tab 34 of end portion 30 clears end edge 36, permitting fingers 36, 38 to engage ledge portions 52, 54 of end portion 32, as described above, thereby locking sleeve 28 in an expanded condition such that sleeve provides a fluid tight seal between gasket 16 and opening 12 of man hole 10.

Advantageously, because engagement surfaces 126, 128 of engagement teeth 124 of clamp 120 are parallel to mating end edges 68a and 68c of end portion 32, and anchor post of cylinder 102 is anchored within opening 76 of end portion 30, the forward driving of piston 106 drives clamp 120 and end portion 32 directly away from end portion 30 along the circumference of sleeve 28 perpendicular to sleeve axis 48. The line contact between parallel surfaces 126, 128 and edges 68a and 68c greatly reduce any possibility of relative lateral movement between end portions 30, 32 of sleeve 28 in directions parallel to sleeve axis 48.

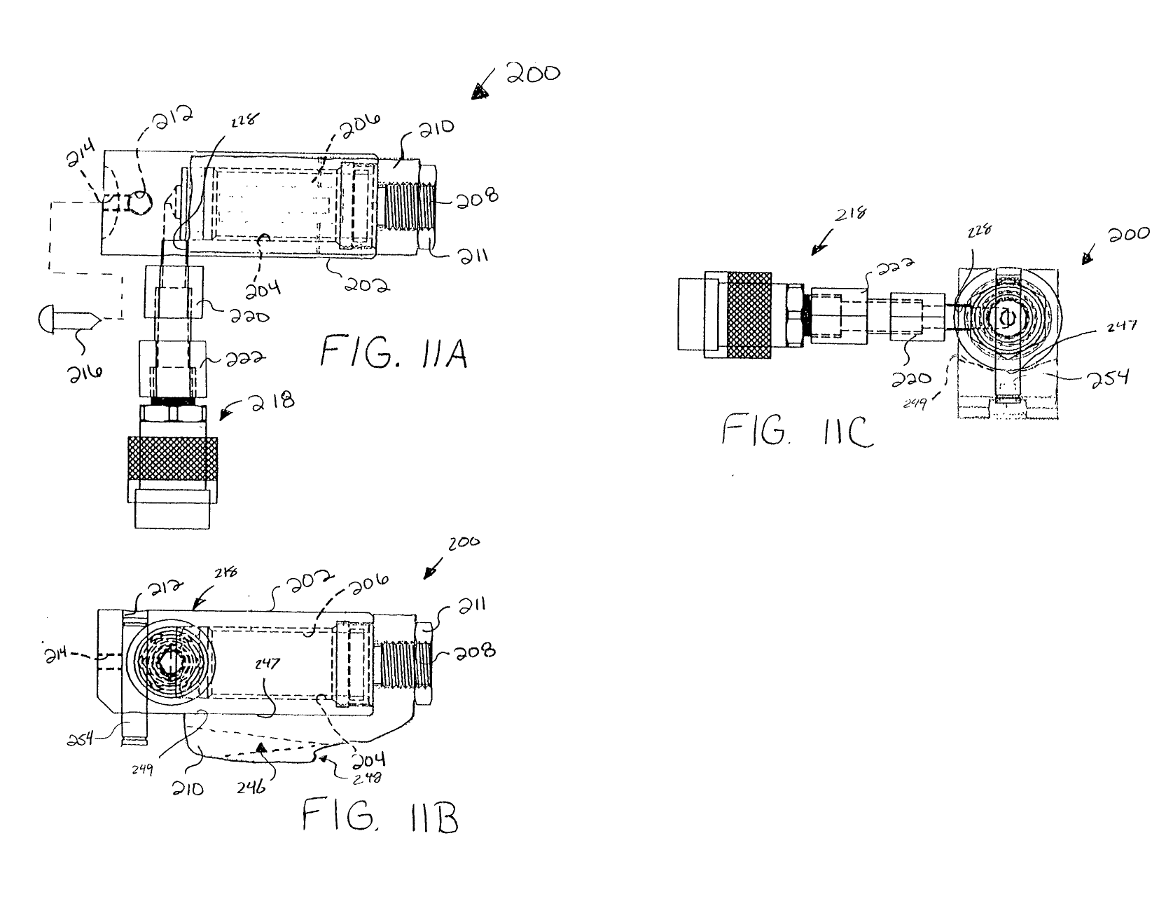

Installation tool 200 is shown in FIGS. 11A through 11C, and includes cylinder 202 having bore 204 therein, in which piston 206 is slidably disposed. Piston 206 includes threaded portion 208, to which push block 210 is removably attached, wherein a portion 246 of push block 210 abuts the underside of cylinder 202. Nut 211 is threadedly engaged with portion 208 to secure push block 210 to piston 206. At an end of cylinder 202 opposite the open end defined therein by bore 204, is through hole 212 for receipt of anchor or stud member, 254 (FIGS. 16A-16B). Hole 214 extends from the exterior of cylinder 202 to bore 212 for receipt of set screw 216 which engages anchor member 254 to maintain anchor member 254 in a selected position. Further included with installation tool 200 is hydraulic assembly 218 for providing hydraulic fluid to cylinder 202 through opening 228 of cylinder 202. Hydraulic assembly 218 is shown as a quick connect/disconnect fitting, including sleeves 220 and 222.

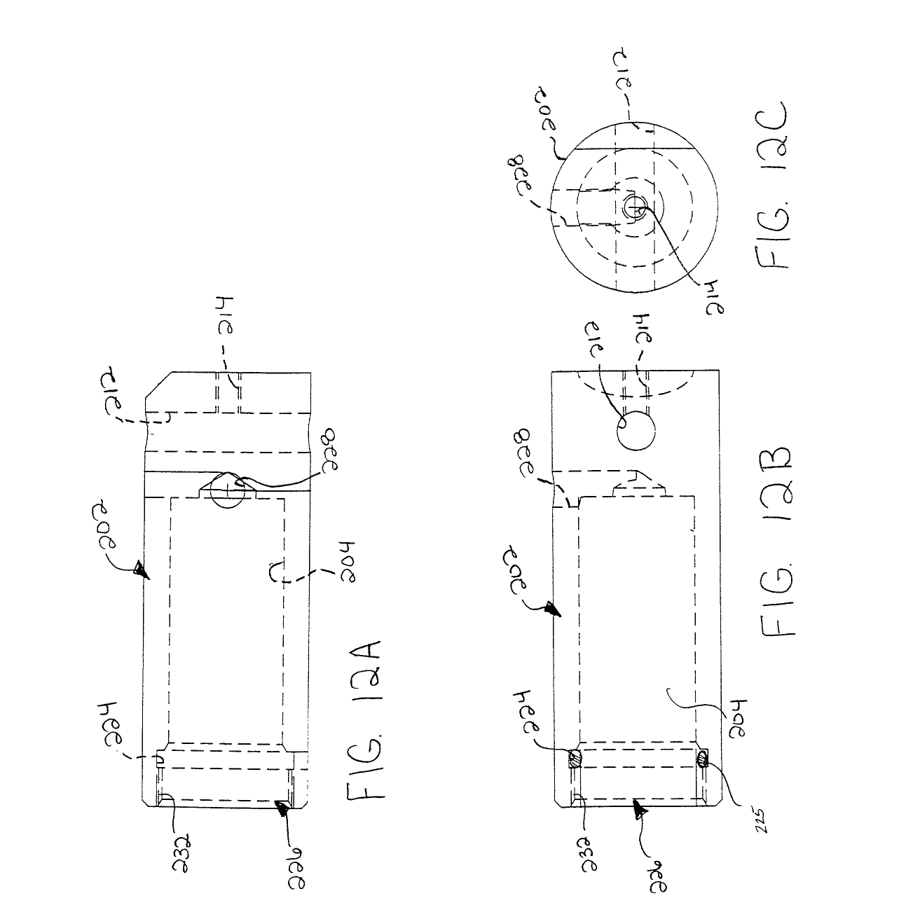

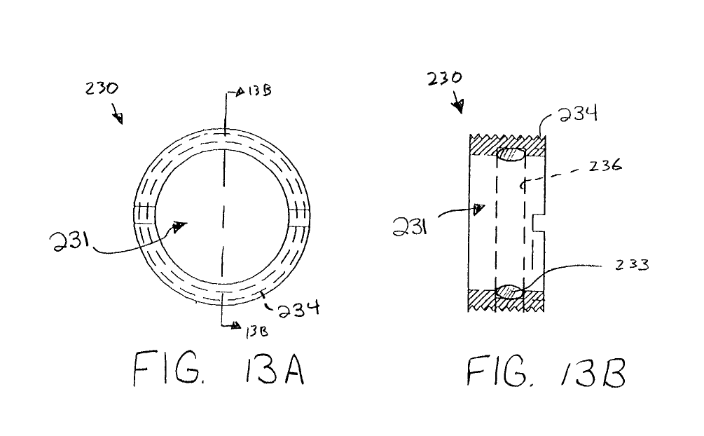

With reference to FIGS. 12A through 12C, cylinder 202 includes bore 204 with opening 226 defining an open end of cylinder 202 through which piston 206 may slide into and out of cylinder 202. Bore 204 includes annular groove 224 therearound for receipt of seal 225 (FIG. 12B) which is disposed between bore 204 and piston 206 to provide a seal between cylinder 202 and piston 206. Opening 226 includes threads 232 for the threaded connection of stop member 230 (FIGS. 13A and 13B) within bore 204 of cylinder 202. Bore 204 includes a larger diameter portion at opening 226 to allow stop member 230 to be disposed therein and yet still accommodate piston 206.

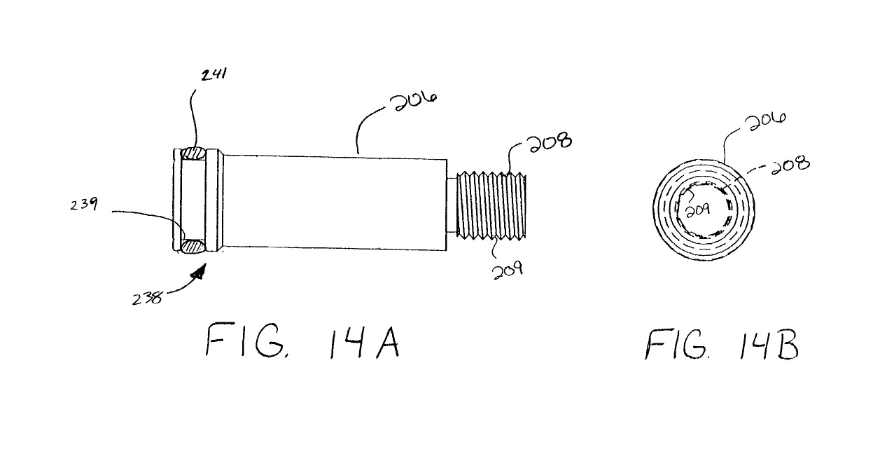

Referring to FIGS. 13A and 13B, an annular stop member 230 includes opening 231 through which piston 206 may slide when stop member 230 is threaded within bore 204 of cylinder 202. Specifically, threads 234, located on the outer periphery of stop member 230, intermesh with threads 232 of bore 204 to provide a secure connection between stop member 230 and cylinder 202. Within stop member 230 is annular groove 236 which receives a seal such as O-ring 233 (FIG. 13B) to provide a seal between stop member 230 and piston 206. Piston 206 (FIGS. 14A and 14B) includes annular protruding portion 238 which abuts stop member 230 when piston 206 is fully extended from cylinder 202. Thus, the foregoing abutment provides a positive limit stop which defines a position of maximum extension of piston 206 and forces piston 206 to remain at least partially within bore 204 of cylinder 202, thereby preventing piston 206 from disengaging from cylinder 202. Piston 206 (FIGS. 14A and 14B) also includes groove 239, which may receive a seal such as O-ring 241, for example, to provide a seal between piston 206 and cylinder 202.

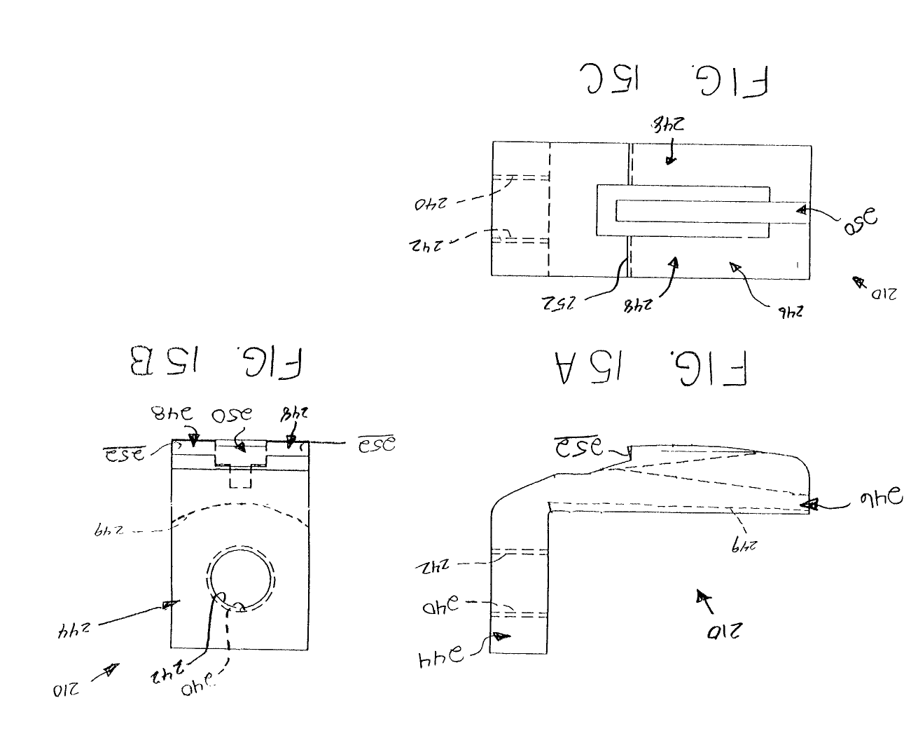

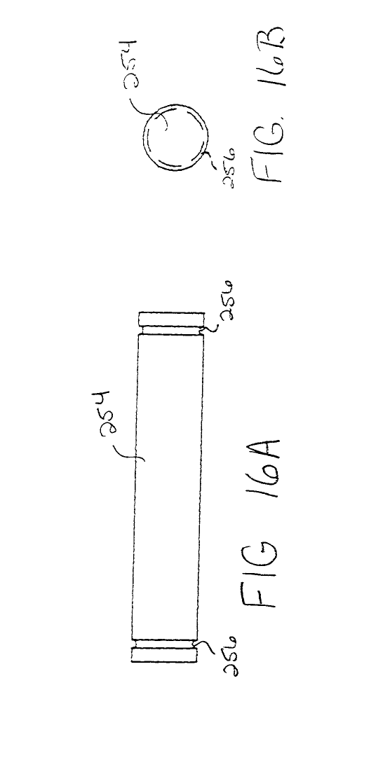

With reference to FIGS. 15A through 15C, push block 210 is shown as having a first upright portion 244 and a second horizontal portion 246. As shown in FIGS. 11B and 11C, second portion 246 includes curved surface 249 which abuts the lower surface 247 of cylinder 202 when push block 210 is attached to piston 206. Push block 210 includes bore 240 with threads 242 for threadedly fitting push block onto threaded portion 208 of piston 206. As shown in FIGS. 11A-11C, nut 211 is threaded on portion 208 of piston 206 to secure push block 210 to piston 206.

Horizontal portion 246 of push block 210 includes a pair of engagement feet 248 between which channel 250 is disposed. Surfaces 252 of engagement portions 248 engage end edges 68a and 68c of end portion 32 of sleeve 28 to spread interlocking portions 30 and 32 of sleeve apart, as discussed further below. Referring to FIG. 11B, it may be seen that the location of the engagement portions 248, at which engagement portions 248 engage mating edges 68a and 68c of end portion 32 of sleeve 28, is at a location beneath cylinder 202 which is spaced rearwardly away from the open end of cylinder 202 and first potion 244 of push block 210.

With reference to FIGS. 16A and 16B, anchor member 254 is shown. Anchor member 254 is inserted through bore 212 of cylinder 202, and an end of anchor member 254 is inserted through hole 76 in sleeve 28 to provide an anchor point between sleeve 28 and installation tool 200. Anchor member 254 may be extended or retracted within bore 212 to vary the length of the portion of anchor member 254 which extends outwardly of cylinder 202, to thereby adjust the length of anchor member 254 with respect to cylinder 202. Set screw 216 engages anchor member 254 to secure anchor member 254 in a selected position within bore 212. Such extension or retraction of anchor 254 is advantageous in that different diameters of gaskets 16 and sleeves 28 may be accommodated easily.

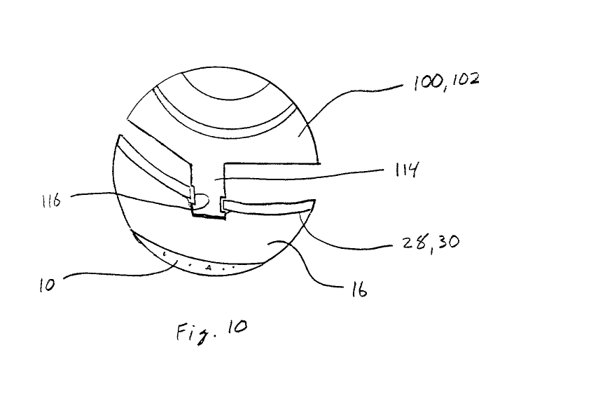

In use, installation tool 200 operates similarly to installation tool 100, as discussed above with reference to FIGS. 6 and 10. Specifically, installation tool 200 is operatively connected to sleeve 28 by inserting anchor member 254 into opening 76 of end 30 of sleeve such that the wall of opening 76 fits into groove 256 of anchor 254, similar to the engagement between anchor post 114 and opening 76 of sleeve 28 as shown in FIG. 10. Push block 210 is aligned with end portion 32 of sleeve 28 such that surfaces 252 of engagement portions 248 are aligned with edges 68a and 68c of end portion 32 of sleeve 28. The location of engagement between surfaces 252 and edges 68a and 68c is located below cylinder 202 and spaced from the front portion of cylinder 202 from which piston 206 extends.

Once surfaces 252 and edges 68a and 68c are in engagement, pressurized hydraulic fluid is pumped through hydraulic assembly 218 into cylinder 202 to move piston 206 and push block 210 outwardly of cylinder 202, engaging surfaces 252 of engagement feet 248 of push block with edges 68a and 68c of end portion 32 of sleeve 28 to thereby expand sleeve 28. As sleeve 28 expands, tab 34 eventually clears end edge 36, thereby allowing fingers 36 and 38 of end portion 30 engage ledge portions 52 and 54 of end portion 32, as described above, to lock sleeve 28 such that a tight seal between gasket 16 and opening 12 in concrete wall 10 is provided.

Like installation tool 100, engagement surfaces 252 of feet 248 are parallel to end edges 68a and 68c of end portion 32 and anchor 254 is anchored within opening 76, thereby allowing the extension of piston 206 to drive push block 210 and end portion 32 away from end portion 30 along the circumference of sleeve 28. This contact between the two surfaces 252 and edges 68a and 68c greatly reduces any lateral movement between end portions 30 and 32 in a direction parallel to axis 48 of sleeve 28. Thus, while a single point of engagement between push block 210 and edge 68 of end portion 32 of sleeve 28 might possibly allow some degree of lateral movement between end portions 30, 32 of sleeve 28, the two points of engagement between push block 210 and edges 68a and 68c provided by the two engagement feet 248 prevent such lateral movement.

Additionally, the abutting engagement between curved surface 249 of second portion 246 of push block with the underside surface of cylinder 202 throughout the movement range of piston 206, as well as the location of the engagement between feet 248 of push block 210 and end portion 32 of sleeve 28 beneath cylinder 202 and spaced from the front of cylinder 202, transfers the non-axial bending forces exerted on piston 206, which may be substantially perpendicular to piston 206, for example, from piston 206 to cylinder 202, thereby distributing such forces between piston 206 and cylinder 202 to prevent bending of piston 206 as piston 206 is driven outwardly of cylinder 202.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A tool for radially expanding a circular sleeve against a gasket, the sleeve having interlocking end portions, at least one of the interlocking end portions having an edge surface, said tool comprising:
a cylinder having a bore therein, said bore defining an open end of said cylinder;
a piston slidably disposed within said bore;
a push block attached to said piston and disposed externally of said cylinder, said push block having at least one engagement member disposed parallel with the edge surface one of the interlocking end portions of the sleeve for engagement therewith, wherein said piston is movable within said cylinder between a first position in which said push block is located adjacent said cylinder to a second position wherein said push block is spaced away from said cylinder.

2. The tool of claim 1, wherein the end portion of the sleeve includes two edge surfaces, and said push block includes two engagement members, said engagement members each disposed parallel with respective edge surfaces of the sleeve.

3. The tool of claim 2, wherein said push block includes a first portion abutting said open end of said cylinder when said cylinder is in said first position, and a second portion disposed beneath said cylinder and abutting said cylinder when said piston is in each of said first and second positions.

4. The tool of claim 3, wherein said engagement members protrude from said second portion of said push block, such that respective points of engagement between said engagement members and said one of said interlocking end portions of said sleeve are located beneath said cylinder.

5. The tool of claim 1, wherein said cylinder further includes a second bore therein, and an anchor member disposed within second bore.

6. The tool of claim 1, further comprising an annular stop member threadedly received in said cylinder bore, said stop member having an internal annular groove therein.

7. The tool of claim 6, wherein said cylinder has an annular groove disposed about said bore, said stop member annular groove and said cylinder annular groove each receiving a seal, said seals abutting said piston whereby a double seal is provided between said piston and said cylinder.

8. The tool of claim 6, wherein said piston further comprises a protrusion at an end thereof, said protrusion abutting said stop member when said piston is in said second position.

9. A tool for radially expanding a circular sleeve against a gasket, the sleeve having interlocking end portions, at least one of the interlocking end portions having an edge surface, said tool comprising:
a cylinder having a bore therein, said bore defining an open end of said cylinder;
a piston slidably disposed within said bore and moveable between a first position and a second position;
a push block attached to said piston, said push block including a first portion disposed adjacent said open end of said cylinder when said piston is in said first position, said push block further including a second portion disposed beneath said cylinder and abutting said cylinder when said piston is in each of said first and second positions.

10. The tool of claim 9, wherein said push block includes at least two engagement members extending from said second portion thereof for engagement with one of the interlocking end portions of the sleeve.

11. The tool of claim 9, wherein said cylinder further includes a second bore therein, and an anchor member removably disposed within said second bore.

12. The tool of claim 9, further comprising an annular stop member threadedly received in said cylinder bore.

13. The tool of claim 12, wherein said piston further comprises a protrusion at an end thereof, said protrusion abutting said stop when said piston is in said second position.

14. The tool of claim 12, wherein said stop member and said cylinder each include annular grooves disposed therearound, said stop member annular groove and said cylinder annular groove each including a seal disposed therein, said seals each abutting said piston whereby a double seal is provided between said piston and said cylinder.

15. A tool for radially expanding a circular sleeve against a gasket, the sleeve having interlocking end portions, at least one of the interlocking end portions having an edge surface, said tool comprising:
a cylinder having a first bore therein defining an open first end of said cylinder, said cylinder further including a second end opposite said first end, said second end including a second bore therethrough;
a piston slidably disposed within said first bore, said piston including a push block attached to an end thereof and disposed externally of said cylinder; and
an anchor member removably disposed within said second bore, said anchor member having a portion extending externally of said cylinder.

16. The tool of claim 15, wherein said anchor member is slidably disposed within said second bore of said cylinder such that the length of said portion thereof which extends externally of said cylinder is adjustable.

17. The tool of claim 16, wherein said cylinder further includes a locking member releasably engaging said anchor member to lock said anchor member in a selected position.

18. A tool for radially expanding a circular sleeve against a gasket, the sleeve having interlocking end portions, at least one of the interlocking end portions having an edge surface, said tool comprising:
a cylinder having a bore therein defining an open end of said cylinder, said cylinder further including an annular groove disposed around said bore;
a piston slidably disposed in said bore;
an annular stop member threadedly received in said open end of said cylinder, said stop member having an internal annular groove therein;
at least two seals, one of said seals being located in each of said cylinder annular groove and said stop member annular groove, said seals each abutting said piston whereby a double seal is provided between said piston and said cylinder.

19. The tool of claim 18, further including a push block removably attached to said piston and disposed externally of said cylinder.

20. The tool of claim 18, wherein said cylinder includes an anchor member removably disposed within an end of said cylinder opposite said open end.

21. The tool of claim 18, wherein said push block includes a first portion, and said piston and said push block are movable between a first position in which a first portion of said push block is located adjacent said open end of said cylinder and a second position in which said first portion of said push block is spaced from said cylinder.

22. The tool of claim 21, wherein said push block includes a second portion disposed beneath said cylinder, said second portion abutting said cylinder when said piston and said push block are in each of said first and second positions.

23. The tool of claim 18, wherein said push block includes at least two engagement members extending therefrom for engagement with one of the interlocking end portions of said sleeve.
